(19) United States
(12) Patent Application Publication
(10) Pub. No.: US 2025/0251502 A1
(43) Pub. Date: Aug. 7, 2025

(54) STRUCTURED LIGHT SENSING MODULE

(71) Applicant: HIMAX TECHNOLOGIES LIMITED, Tainan City (TW)

(72) Inventors: Hsueh-Tsung Lu, Tainan City (TW); Wu-Feng Chen, Tainan City (TW)

(73) Assignee: HIMAX TECHNOLOGIES LIMITED, Tainan City (TW)

(21) Appl. No.: 18/433,446

(22) Filed: Feb. 6, 2024

(51) Int. Cl. G01S 7/499; G01S 7/481; G01S 7/4913; G01S 17/89

(52) U.S. Cl. CPC G01S 7/499; G01S 7/4816; G01S 7/4913; G01S 17/89

(57) ABSTRACT

A structured light sensing module including a structured light source, a sensing device and a plurality of polarizing units is provided. The structured light source is configured to emit structured light having a polarization toward a sensing target. The sensing device is configured to receive the structured light reflected from the sensing target and has a plurality of sensing units. The polarizing units are disposed on a side of a light-receiving surface of the sensing device, and respectively overlap the plurality of sensing units. Each polarizing unit includes at least four polarizing patterns. Each of the at least four polarizing patterns has an absorption axis. The axial directions of the absorption axes of the at least four polarizing patterns are different from each other.

### BACKGROUND

### Technical Field

This disclosure relates to a sensing technology, and in particularly, relates to a structured light sensing module.

### Description of Related Art

With the rise of 3D face recognition applications in the mobile phone industry, various three-dimensional (3D) depth sensing technologies are booming. Among them, 3D depth sensing technology using structured light has been widely used in fields such as structured light 3D scanners due to its efficient acquisition with high accuracy and high spatial resolution. Structured light works by projecting known patterns onto the sensing target, recording the pattern distortion, and decoding depth information from the acquired image. However, the reflected patterns are sensitive to optical interference from the environment (for example, ambient light), which reduces the signal-to-noise ratio (SNR) of the acquired image.

Therefore, in addition to image capture with structured light, image capture of the sensing target without structured light projection has been proposed to solve the problem aforementioned. In the proposal, an active light source is required to time-sequentially manipulate the projected light. The two images acquired with and without structured light may be subtracted from each other or calculated based on a specific weight factor to reduce the influence from the environment and improve the SNR of the acquired image. However, when the object (i.e. sensing target) is moving and the frame rate of the image capture is not fast enough, there will be some differences between the two images, causing the influence from environment to be misestimated, and abnormal depth of the edge of the moving object to be calculated.

### SUMMARY

In view of the foregoing problems, the disclosure provides a structured light sensing module capable of eliminating the influence of ambient light, which may improve the SNR of the image captured outdoor and provide depth information with higher accuracy.

The disclosure provides a structured light sensing module including a structured light source, a sensing device and a plurality of polarizing units. The structured light source is configured to emit structured light having a polarization toward a sensing target. The sensing device is configured to receive the structured light reflected from the sensing target and has a plurality of sensing units. The polarizing units are disposed on a side of a light-receiving surface of the sensing device, and respectively overlap the plurality of sensing units. Each polarizing unit includes at least four polarizing patterns. Each of the at least four polarizing patterns has an absorption axis. The axial directions of the absorption axes of the at least four polarizing patterns are different from each other.

Based on the above, in the structured light sensing module according to an embodiment of the disclosure, each sensing unit of the sensing device is overlapped with at least four polarizing patterns. Each polarizing pattern has an absorption axis, and the axial directions of the absorption axes of the at least four polarizing patterns are different from each other. The configuration of the polarizing patterns overlapping each sensing unit enables the structured light sensing module to distinguish between the structured light and the ambient light. Such that, the impact of the ambient light on the captured image may be eliminated, and the SNR of captured image may be significantly optimized. Accordingly, the structured light sensing module may provide more accurate depth information.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a structured light sensing module according to one embodiment of the disclosure.

FIG. 2 is a schematic diagram illustrating the arrangement of a microlens array, a polarizing layer and a sensing device of the structured light sensing module in FIG. 1.

FIG. 3A is a schematic top view illustrating the relationship between axial directions of a polarizing unit in FIG. 2 and the polarization direction of structured light of one embodiment of the disclosure.

FIG. 3B is a schematic top view illustrating the relationship between axial directions of a polarizing unit in FIG. 2 and the polarization direction of structured light of another embodiment of the disclosure.

FIG. 4 is a schematic diagram illustrating input and output of a polarization analysis module in FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

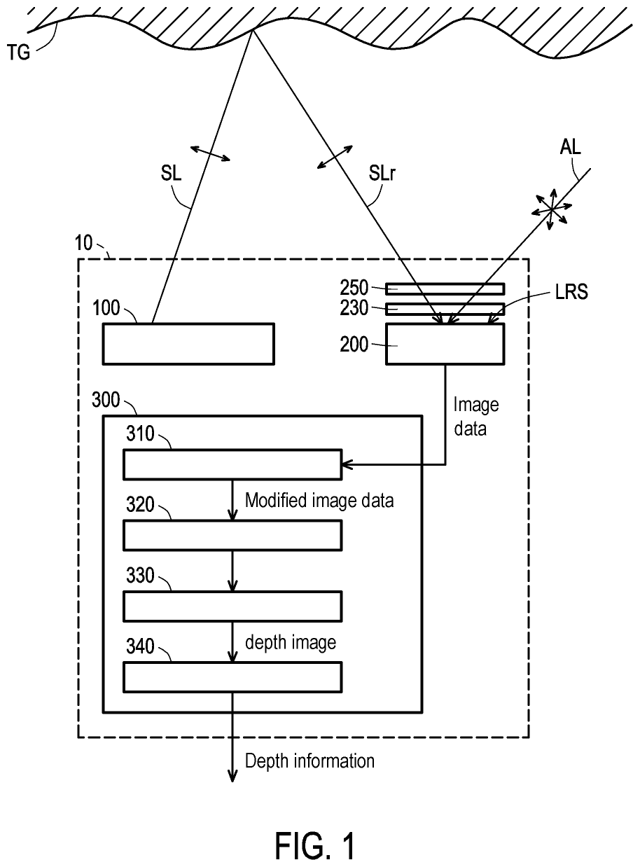

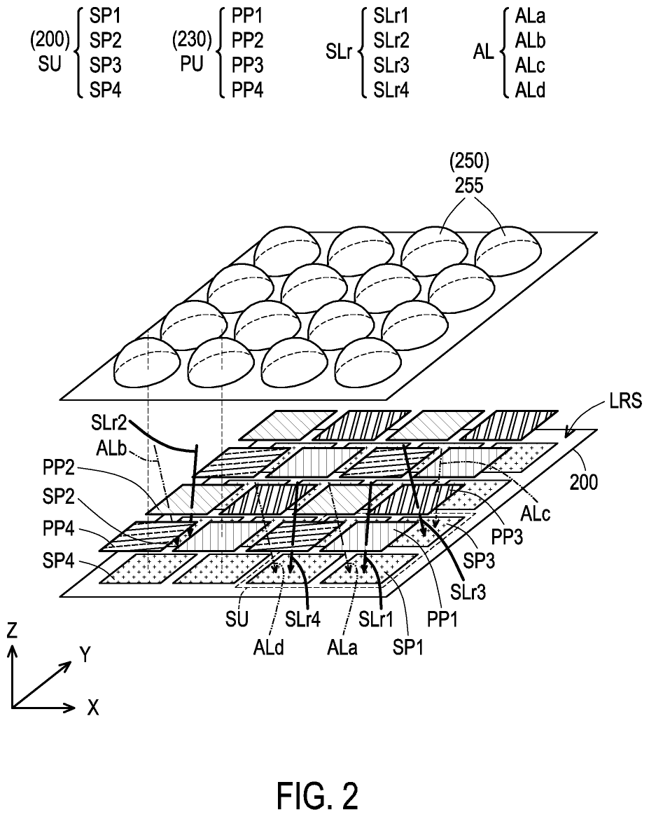

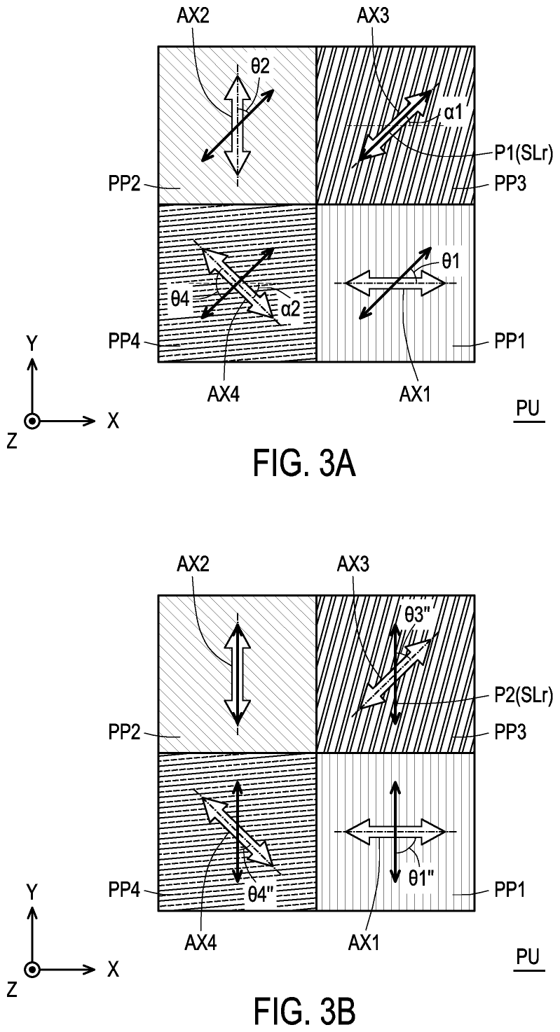

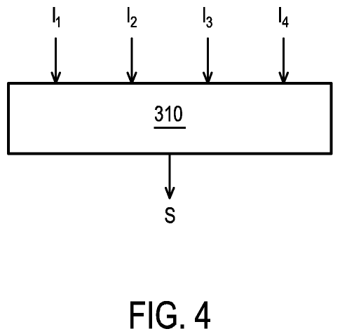

FIG. 1 is a schematic diagram of a structured light sensing module according to one embodiment of the disclosure. FIG. 2 is a schematic diagram illustrating the arrangement of a microlens array, a polarizing layer and a sensing device of the structured light sensing module in FIG. 1. FIG. 3A is a schematic top view illustrating the relationship between axial directions of a polarizing unit in FIG. 2 and the polarization direction of structured light of one embodiment of the disclosure. FIG. 3B is a schematic top view illustrating the relationship between axial directions of a polarizing unit in FIG. 2 and the polarization direction of structured light of another embodiment of the disclosure. FIG. 4 is a schematic diagram illustrating input and output of a polarization analysis module in FIG. 1.

Referring to FIG. 1 and FIG. 2, a structured light sensing module 10 includes a structured light source 100 and a sensing device 200. The structured light source 100 is configured to emit structured light SL toward a sensing target TG. Particularly, the structured light SL is polarized (i.e. the structured light SL has a polarization). In the embodiment, the structured light source 100 may be, for example, a structured light projector that projects known patterns (not illustrated) onto the sensing target TG. The type of pattern of structured light SL may be any one of grating type, light spot type, dapple type, non-uniform speckle type, etc.

The sensing device 200 is configured to receive the structured light SLr reflected from the sensing target TG. The sensing device 200 has a plurality of sensing units SU. In the embodiment, the plurality of sensing units SU may be respectively arranged in a direction X and a direction Y. The direction X may be perpendicular to the direction Y. Each of the sensing units SU includes a first sensing pixel SP1, a second sensing pixel SP2, a third sensing pixel SP3 and a fourth sensing pixel SP4. For example, these sensing pixels may be a plurality of single photon avalanche diodes (SPADs), but the disclosure is not limited thereto.

In each sensing unit SU, the number of the sensing pixels arranged in each of the direction X and the direction Y may be two. That is, the four sensing pixels of each sensing unit SU may be arranged in a 2×2 array, but the disclosure is not limited thereto.

The structured light sensing module 10 further includes a polarizing layer 230 disposed on a side of a light-receiving surface LRS of the sensing device 200. The polarizing layer 230 overlaps the plurality of sensing units SU of the sensing device 200 along a direction Z perpendicular to the light-receiving surface LRS. In the embodiment, the polarizing layer 230 includes a plurality of polarizing units PU. Theses polarizing units PU may be respectively arranged in the direction X and the direction Y.

More specifically, the plurality of sensing units SU are respectively overlapped with the plurality of polarizing units PU along the direction Z. Each of the polarizing unit PU includes a first polarizing pattern PP1, a second polarizing pattern PP2, a third polarizing pattern PP3 and a fourth polarizing pattern PP4. For example, the first sensing pixel SP1, the second sensing pixel SP2, the third sensing pixel SP3 and the fourth sensing pixel SP4 of each sensing unit SU are respectively overlapped with the first polarizing pattern PP1, the second polarizing pattern PP2, the third polarizing pattern PP3 and the fourth polarizing pattern PP4 of a corresponding polarizing unit PU along the direction Z (as illustrated in FIG. 2).

Referring to FIG. 2 and FIG. 3A, each of the polarizing patterns of each polarizing unit PU has an absorption axis, and the axial directions of the absorption axes of the polarizing patterns of each polarizing unit PU are different from each other. For example, in the embodiment, the absorption axis AX1 of the first polarizing pattern PP1 may be parallel to the direction X, and the absorption axis AX2 of the second polarizing pattern PP2 may parallel to the direction Y. That is, the axial direction of the absorption axis AX1 is perpendicular to the axial direction of the absorption axis AX2.

Similarly, the axial direction of the absorption axis AX3 is perpendicular to the axial direction of the absorption axis AX4. In the embodiment, the axial directions of the absorption axis AX3 and the absorption axis AX4 intersect the direction X and the direction Y. For example, an included angle α1 between the axial direction of the absorption axis AX3 and the direction X is 45 degrees, and an included angle α2 between the axial direction of the absorption axis AX4 and the direction X is 45 degrees. That is, an included angle between the axial direction of the absorption axis AX1 and the axial direction of the absorption axis AX3 is 45 degrees. However, the disclosure is not limited thereto. In other embodiment, the included angle α1 may be 30 degrees and the included angle α2 may be 120 degrees.

Referring to FIG. 1 and FIG. 2, it should be noted that the structured light SLr reflected from the sensing target TG may include a first portion SLr1 passing through the first polarizing pattern PP1, a second portion SLr2 passing through the second polarizing pattern PP2, a third portion SLr3 passing through the third polarizing pattern PP3 and a fourth portion SLr4 passing through the fourth polarizing pattern PP4. Correspondingly, the first sensing pixel SP1, the second sensing pixel SP2, the third sensing pixel SP3 and the fourth sensing pixel SP4 of each sensing unit SU are configured to respectively receive the first portion SLr1, the second portion SLr2, the third portion SLr3 and the fourth portion SLr4 of the structured light SLr reflected from the sensing target TG.

The sensing device 200 is also configured to generate image data according to a plurality of sensing results of the first sensing pixel SP1, the second sensing pixel SP2, the third sensing pixel SP3 and the fourth sensing pixel SP4 of each sensing unit SU. The sensing results may be, for example, the electrical current converted from the photonic energy received by the sensing pixels of sensing device 200. The sensing device 200 may include a time-to-digital converter (not illustrated), and the sensing results of the sensing pixels are output to the time-to-digital converter. The time-to-digital converter may perform a plurality of times of integration operations on the sensing results of each of the sensing pixels to generate image data (i.e. captured image). The image data may be stored in a memory (not illustrated) of the sensing device 200 or a buffer of the time-to-digital converter.

For example, the image data may include light intensity of the structured light SLr received by each sensing pixel. Referring to FIG. 2 and FIG. 3A, in the embodiment, the structured light SL has a polarization P1. The direction (i.e. polarization direction) of the polarization P1 may be parallel to the absorption axis AX3 of the polarizing pattern PP3. That is, an included angle θ1 between the direction of the polarization P1 and the axial direction of the first absorption axis AX1 and an included angle θ2 between the direction of the polarization P1 and the second absorption axis AX2 may be 45 degrees, and an included angle θ4 between the direction of the polarization P1 and the axial direction of the fourth absorption axis AX4 may be 90 degrees.

According to the relationship between the direction of the polarization P1 and the axial direction of the absorption axis of each polarizing pattern, the light intensity received by the first sensing pixel SP1, the light intensity received by the second sensing pixel SP2, the light intensity received by the third sensing pixel SP3 and the light intensity received by the fourth sensing pixel SP4 are I₁, I₂, I₃ and I₄, respectively.

In the embodiment, since the polarization direction of the fourth portion SLr4 is perpendicular to the axial direction of the absorption axis AX4 of the fourth polarizing pattern PP4, the fourth portion SLr4 may pass through the fourth polarizing pattern PP4 without significant loss. Contrarily, the third portion SLr3 may be almost absorbed by the third polarizing pattern PP3 due to the polarization direction of the third portion SLr3 is parallel to the axis direction of the absorption axis AX3. The first portion SLr1 may be partially absorbed by the first polarizing pattern PP1 due to the polarization direction of the first portion SLr1 is not perpendicular to or parallel to the axial direction of the first absorption axis AX1. The second portion SLr2 may be partially absorbed by the second polarizing pattern PP2 due to the polarization direction of the second portion SLr2 is not perpendicular to or parallel to the axial direction of the second absorption axis AX2.

Accordingly, the transmittances of the first polarizing pattern PP1, the second polarizing pattern PP2, the third polarizing pattern PP3 and the fourth polarizing pattern PP4 for the structured light SLr having a polarization P1 may be 50%, 50%, 0% and 100%, respectively. However, the disclosure is not limited thereto. Referring to FIG. 3B, in other embodiment, the structured light SLr″ may have a polarization P2 whose direction is parallel to the axial direction of the absorption axis AX2 of the second polarizing pattern PP2. That is, an included angle θ3″ between the direction of the polarization P2 and the axial direction of the third absorption axis AX3 and an included angle θ4″ between the direction of the polarization P2 and the fourth absorption axis AX4 may be 45 degrees, and an included angle θ1″ between the direction of the polarization P2 and the axial direction of the first absorption axis AX1 may be 90 degrees. Therefore, the transmittances of the first polarizing pattern PP1, the second polarizing pattern PP2, the third polarizing pattern PP3 and the fourth polarizing pattern PP4 for the structured light SLr having a polarization P2 may be 100%, 0%, 50% and 50%, respectively.

Referring to FIG. 1 and FIG. 2, the sensing device 200 receives not only the structured light SLr but also ambient light AL. In detail, the ambient light AL may include a first portion ALa passing through the first polarizing pattern PP1, a second portion ALb passing through the second polarizing pattern PP2, a third portion ALc passing through the third polarizing pattern PP3 and a fourth portion ALd passing through the fourth polarizing pattern PP4. In addition to the structured light SLr, the first sensing pixel SP1, the second sensing pixel SP2, the third sensing pixel SP3 and the fourth sensing pixel SP4 may also receive the first portion ALa, the second portion ALb, the third portion ALc and the fourth portion ALd of the ambient light AL, respectively.

Since the ambient light AL is unpolarized, the transmittance of each of the first polarizing pattern PP1, the second polarizing pattern PP2, the third polarizing pattern PP3 and the fourth polarizing pattern PP4 for the unpolarized ambient light AL may be 50%. More specifically, a part of the light intensity received by each sensing pixel is contributed by the ambient light AL which may reduce the signal-to-noise ratio (SNR) of the image data.

In the embodiment, the structured light sensing module 10 further includes a processing unit 300. The processing unit 300 is electrically coupled to the sensing device 200, and is configured to generate a depth information of the sensing target TG according to the image data from the sensing device 200. The processing unit 300 includes a polarization analysis module 310 which is configured to calculate light intensity S received by each of the sensing units SU according to the light intensity I₁ received by the first sensing pixel SP1, the light intensity I₂ received by the second sensing pixel SP2, the light intensity I₃ received by the third sensing pixel SP3 and the light intensity I₄ received by the fourth sensing pixel SP4 (as illustrated in FIG. 4), and generate a modified image data.

For example, in the embodiment, the light intensity S satisfies the following equation: S=\sqrt{S₁²+S₂²}, wherein S₁=I₁−I₂, and S₂+I₃−I₄. Such that, the noise in the sensing results caused by the ambient light AL may be significantly eliminated, and hence improving the SNR of the image data.

However, the disclosure is not limited thereto. In another embodiment, the light intensity received by each of the sensing units SU may satisfies the following equation: S=Iₘₐₓ−Iₘᵢₙ, wherein Iₘₐₓ and Iₘᵢₙ are the maximum light intensity and the minimum light intensity of I₁, I₂, I₃ and I₄, respectively. That is, the minimum light intensity of I₁, I₂, I₃ and I₄ may be approximately the performance of the ambient light AL.

It should be noted that, in the embodiment, the resolution of the modified image data generated by the polarization analysis module 310 is one-quarter of the resolution of the image data generated by the sensing device 200 due to the number of the sensing pixels of each sensing unit SU is four, but the disclosure is not limited thereto. For example, if the resolution of the image data is Rₓ×R_{y}, then the resolution of modified image data will be Rₓ/2×R_{y}/2, wherein Rₓ is the resolution of the image data along the direction X, and R_{y} is the resolution of the image data along the direction Y.

Furthermore, the processing unit 300 further includes a depth decoder 330 which is configured to generate a depth image according to the modified image data. In the embodiment, the processing unit 300 may optionally include a pre-processing module 320 and a post-processing module 340. The pre-processing module 320 is electrically coupled to the polarization analysis module 310 and the depth decoder 330, and is configured to perform image processing on the modified image data before the modified image data is transmitted to the depth decoder 330. For example, the image processing of the modified image data in the pre-processing module 320 may include image undistortion, contrast enhancement, etc.

The post-processing module 340 is electrically coupled to the depth decoder 330, and is configured to perform image processing on the depth image from the depth decoder 330, and output a depth information. For example, the image processing of depth image in the post-processing module 340 may include denoise, smoothing, etc.

In the embodiment, the structured light sensing module 10 may further include a microlens array 250 disposed on the side of the light-receiving surface LRS of the sensing device 200. Specifically, the polarizing layer 230 is located between the microlens array 250 and the sensing device 200. For example, the microlens array 250 has a plurality of microlenses 255, and the microlenses 255 respectively overlap the plurality of sensing pixels of the sensing device 200, but the disclosure is not limited thereto. The configuration of the microlens array 250 may increase the light collection efficiency of the structured light sensing module 10.

It should be noted that, in the embodiment, the number of the sensing pixels in each sensing unit SU and the number of the polarizing patterns in each polarizing unit PU are both four as an example for illustrative explanation, and do not mean that the present invention is limited by the content disclosed in the drawings. In other embodiment, the number of sensing pixels in each sensing unit and the number of polarizing patterns of each polarizing unit may be greater than four according to the needs of actual applications.

In summary, in the structured light sensing module according to an embodiment of the disclosure, each sensing unit of the sensing device is overlapped with at least four polarizing patterns. Each polarizing pattern has an absorption axis, and the axial directions of the absorption axes of the at least four polarizing patterns are different from each other. The configuration of the polarizing patterns overlapping each sensing unit enables the structured light sensing module to distinguish between the structured light and the ambient light. Such that, the impact of the ambient light on the captured image may be eliminated, and the SNR of captured image may be significantly optimized. Accordingly, the structured light sensing module may provide more accurate depth information.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A structured light sensing module, comprising:
a structured light source, configured to emit structured light having a polarization toward a sensing target;
a sensing device, configured to receive the structured light reflected from the sensing target, and having a plurality of sensing units; and
a plurality of polarizing units, disposed on a side of a light-receiving surface of the sensing device, and respectively overlapping the plurality of sensing units, wherein each polarizing unit includes at least four polarizing patterns, each of the at least four polarizing patterns has an absorption axis, and axial directions of the absorption axes of the at least four polarizing patterns are different from each other.

2. The structured light sensing module according to claim 1, wherein the at least four polarizing patterns includes a first polarizing pattern, a second polarizing pattern, a third polarizing pattern and a fourth polarizing pattern, the absorption axis of the first polarizing pattern is perpendicular to the absorption axis of the second polarizing pattern, and the absorption axis of the third polarizing pattern is perpendicular to the absorption axis of the fourth polarizing pattern.

3. The structured light sensing module according to claim 2, wherein an included angle between an axial direction of the absorption axis of the first polarizing pattern and an axial direction of the absorption axis of the third polarizing pattern is 45 degrees.

4. The structured light sensing module according to claim 2, wherein the structured light reflected from the sensing target includes a first portion passing through the first polarizing pattern, a second portion passing through the second polarizing pattern, a third portion passing through the third polarizing pattern and a fourth portion passing through the fourth polarizing pattern, and each of the sensing units includes a first sensing pixel, a second sensing pixel, a third sensing pixel and a fourth sensing pixel configured to respectively receive the first portion, the second portion, the third portion and the fourth portion of the structured light.

5. The structured light sensing module according to claim 4, the sensing device is also configured to generate image data according to a plurality of sensing results of the first sensing pixel, the second sensing pixel, the third sensing pixel and the fourth sensing pixel of each sensing unit.

6. The structured light sensing module according to claim 5, further comprising:
a processing unit, electrically coupled to the sensing device, and configured to generate a depth information of the sensing target according to the image data.

7. The structured light sensing module according to claim 6, wherein the processing unit includes:
a polarization analysis module, configured to calculate light intensity S received by each of the sensing units according to light intensity I₁ received by the first sensing pixel, light intensity I₂ received by the second sensing pixel, light intensity I₃ received by the third sensing pixel and light intensity I₄ received by the fourth sensing pixel, and generate a modified image data.

8. The structured light sensing module according to claim 7, wherein the light intensity S received by each of the sensing units satisfies the following equation:
S=\sqrt{S₁²+S₂²}, wherein S₁=I₁−I₂, and S₂+I₃−I₄.

9. The structured light sensing module according to claim 7, wherein the light intensity S received by each of the sensing units satisfies the following equation:
S=Iₘₐₓ−Iₘᵢₙ, wherein Iₘₐₓ is maximum light intensity of I₁, I₂, I₃ and I₄, and Iₘᵢₙ is minimum light intensity of I₁, I₂, I₃ and I₄.

10. The structured light sensing module according to claim 7, wherein the processing unit further includes:
a depth decoder, configured to generate a depth image according to the modified image data.

11. The structured light sensing module according to claim 10, wherein the processing unit further includes:
a pre-processing module, configured to perform image processing on the modified image data before the modified image data is transmitted to the depth decoder.

12. The structured light sensing module according to claim 10, wherein the processing unit further includes:
a post-processing module, configured to perform image processing on the depth image from the depth decoder and output a depth information.

13. The structured light sensing module according to claim 1, further comprising:
a microlens array, disposed on the side of the light-receiving surface of the sensing device, wherein the polarizing units are located between the microlens array and the sensing device.
